(19) United States
(12) Patent Application Publication
(10) Pub. No.: US 2008/0074741 A1
(43) Pub. Date: Mar. 27, 2008

(54) Enclosure having lenticular lens member

(76) Inventor: Cheryl Bartley, Powell, TN (US)

Correspondence Address: LUEDEKA, NEELY & GRAHAM, P.C., P O BOX 1871, KNOXVILLE, TN, 37901, US

(21) Appl. No.: 11/528,120

(22) Filed: Sep. 27, 2006

(51) Int. Cl. G03B 21/60

(52) U.S. Cl. 359/455

(57) ABSTRACT

A shower door having a lenticular image. The door member includes a first substrate layer on which a first interlaced image is printed. The door member also includes a lenticular lens layer registered with the interlaced image to have the effect of displaying a lenticular image. A frame preferably seals the edges of the door member to minimize intrusion of foreign matter including water. The door member may include an adhesive layer to attach the substrate to the lenticular lens layer or the substrate may be laminated to the lenticular lens layer.

### FIELD

This disclosure relates to the field of shower enclosures. More particularly, the disclosure relates to a shower enclosure that includes at least one lenticular image.

### BACKGROUND

Lenticular imaging technology has been developing for hundreds of years, but the twentieth century brought new techniques allowing for more detailed and efficient creation of lenticular images. The science behind lenticular imaging technology is known to those skilled in the art and is not discussed in detail here. However, basic concepts and the visual effects realized by the use of lenticular imaging technology are briefly discussed herein for illustration.

A lenticular image generally requires two parts including a printed image and a lenticular lens layer. The printed image is printed in an interlaced fashion, containing a plurality of sub-images. The printed image may be printed on a substrate that is later aligned with the lenticular lens layer or, as an alternative, the printed image may be printed directly onto the lenticular lens layer. When the interlaced printed image is viewed through the lenticular lens layer, one or more sub-images appear through the lenticular lens layer depending on the angle at which the printed image is viewed. The associated effect of this technology can create the sensation of movement (i.e., animation), the succession of two or more sub-images changing from one to another (i.e., “flip” or “flipping”), or other similar effects.

In order for an animation, flip, or other similar effect to be experienced by a viewer, the interlaced printed image must be lined up properly with the lenticular lens layer-a process commonly referred to as “registration.” Therefore, the registration process must be precise for a high quality lenticular viewing effect to be produced. Similarly, if the printed image is printed directly onto the back of the lenticular lens layer, the printing step(s) must be precise. Any event causing misalignment or otherwise disrupting the relative position of the printed image and the lens layer has the potential to partially or fully disrupt the desired lenticular imaging effect. Such events could include water intrusion or other similar chemical or physical interference after registration.

The present disclosure advantageously enables the use of lenticular images in wet environments, particularly with shower enclosures.

### SUMMARY

The disclosure includes embodiments of a shower door that includes at least one lenticular image. In one embodiment, the shower door includes a frame that holds a door member. The door member includes a first substrate layer on which a first interlaced image is printed. The door member also includes a first lenticular lens layer registered with the interlaced image to have the effect of displaying a first lenticular image. The frame preferably seals the edges of the door member to minimize intrusion of foreign matter including water. In a related embodiment, the door member includes an adhesive layer to attach the substrate to the lenticular lens layer or the substrate is laminated to the lenticular lens layer.

In another embodiment, the door member further includes a first protective layer arranged adjacent to the lenticular lens layer. In a related embodiment, the door member includes a second protective layer such that the substrate layer and the lenticular lens layer are arranged between the first protective layer and the second protective layer.

In yet another embodiment, the door member further includes a second substrate layer on which a second interlaced image is printed. The second interlaced image is preferably a mirror image of the first interlaced image. This embodiment also includes a second lenticular lens layer. The second substrate layer and the second lens layer are arranged such that a second lenticular image is displayed in a direction substantially opposite to the displayed first lenticular image. In a related embodiment, the door member further includes a first protective layer arranged adjacent to the first lenticular lens layer, defining an outer surface of the door member. In another related embodiment, the door member further includes a protective layer arranged between the first substrate layer and the second substrate layer. In a similar embodiment, the door member includes a first protective layer and a second protective to form the respective outer layers of the door member.

In a different set of embodiments, the door member includes a substrate with a first interlaced image printed on a first side of the substrate and a second interlaced image printed on a second side of the substrate. The second interlaced image is preferably a mirror image of the first interlaced image. A pair of lenticular lens layers—a first lens layer and a second lens layer—are placed on an opposing side of the substrate such that a first lenticular image is displayed from a first side of the substrate and a second lenticular image is displayed from a second side of the substrate. Related embodiments with protective layers are similar to those discussed above. For example, in one embodiment, a first protective layer is arranged as a part of the door member adjacent to the first lenticular lens layer, thereby forming a first outer layer of the door member. In a related embodiment, a second protective layer is arranged adjacent to the second lenticular lens layer, forming a second outer layer of the door member.

Another set of embodiments includes a frame and a door member. In a first embodiment, the door member includes an interlace image printed on a first lenticular lens layer such that a first lenticular image is displayed. In a related embodiment, the door member also includes a first protective layer. In another related embodiment, the door member further includes a second protective layer such that the first protective layer and the second protective layer form outer layers, respectively, of the door member.

In yet another set of embodiments, the door member includes a first interlaced image printed on a first lenticular lens layer and a second interlaced image printed on a second lenticular lens layer. The layers are arranged such that a first lenticular image is displayed from a first side of the door member and a second lenticular image is displayed form a second side of the door member. In a related embodiment, the door member also includes a first protective layer adjacent to the first lenticular lens layer, thereby forming an outer layer of the door member. In a similar embodiment, the door member further includes a first protective layer arranged between the first lenticular lens layer and the second lenticular lens layer. In yet another related embodiment, the door member includes a first protective layer and a second protective layer such that the first protective layer and the second protective layer form outer layers, respectively, of the door member.

The disclosure also includes embodiments of a method for manufacturing a shower door that includes a lenticular image. In one embodiment, the method includes the steps of printing an interlace image on a substrate and framing the substrate and a lenticular lens layer within a frame assembly such that a lenticular image is displayed.

These and other features, aspects, and advantages of the disclosure will become better understood with regard to the following description, appended claims, and accompanying drawings.

### BRIEF DESCRIPTION OF THE DRAWINGS

Further advantages of the disclosure are apparent by reference to the detailed description in conjunction with the figures, wherein elements are not to scale so as to more clearly show the details, wherein like reference numbers indicate like elements throughout the several views, and wherein:

FIGS. 1-6 show various configurations of a shower enclosure incorporating lenticular images according to the disclosure;

FIGS. 7-12 are exploded cross-sectional side views of various embodiments of shower enclosure members incorporating lenticular images according to the disclosure; and

FIG. 13 shows an exploded cross-sectional side view of another embodiment of a shower enclosure having a lenticular image according to the disclosure.

### DETAILED DESCRIPTION

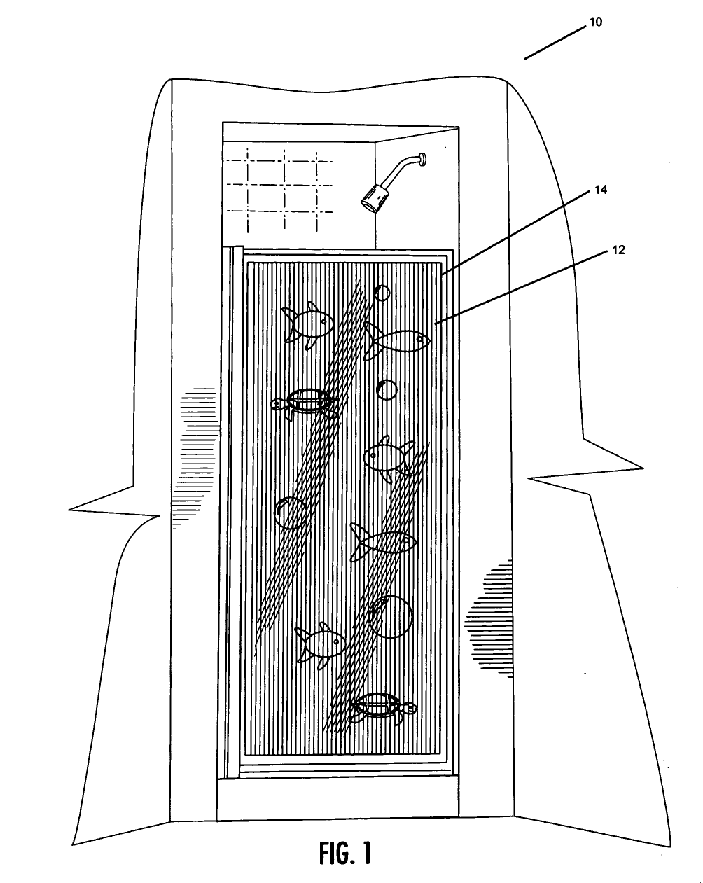

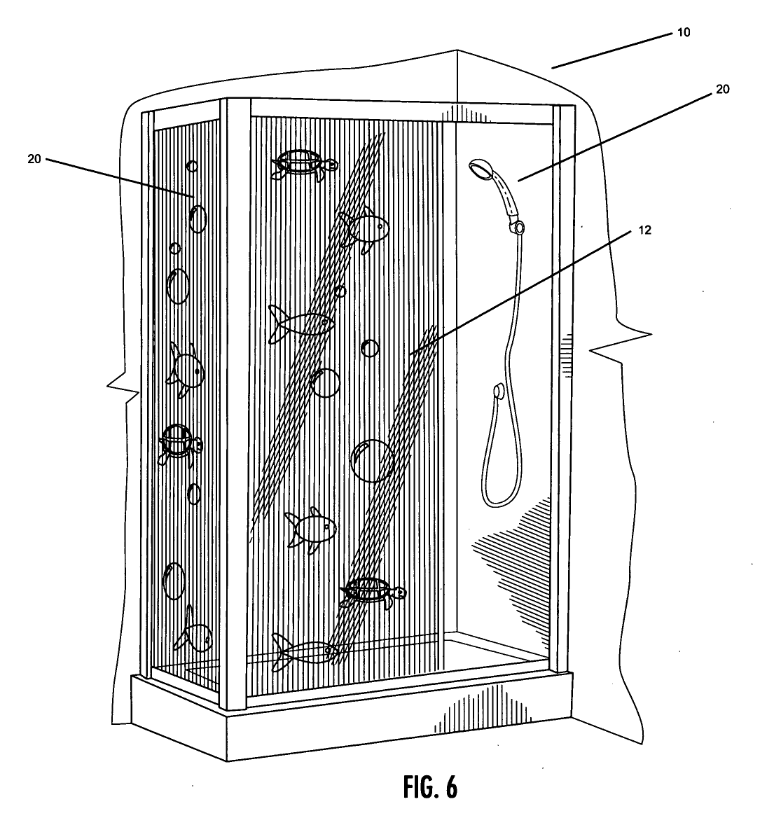

Typically in many homes, glass or plastic enclosures enclose showering or bathing areas. FIGS. 1-6 depict various configurations of shower/baths enclosures 10 provided with lenticular images pursuant to the disclosure for enclosing a bathing area such as a shower or bath. The lenticular images are represented in the drawings by drawings of fish, turtles, and bubbles. These drawings are representational only and the lenticular images may be of other content.

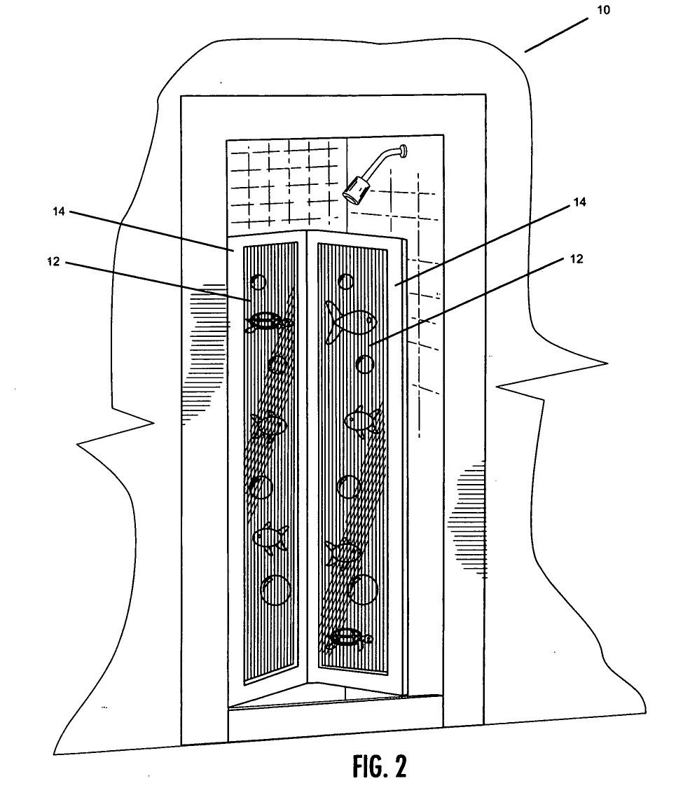

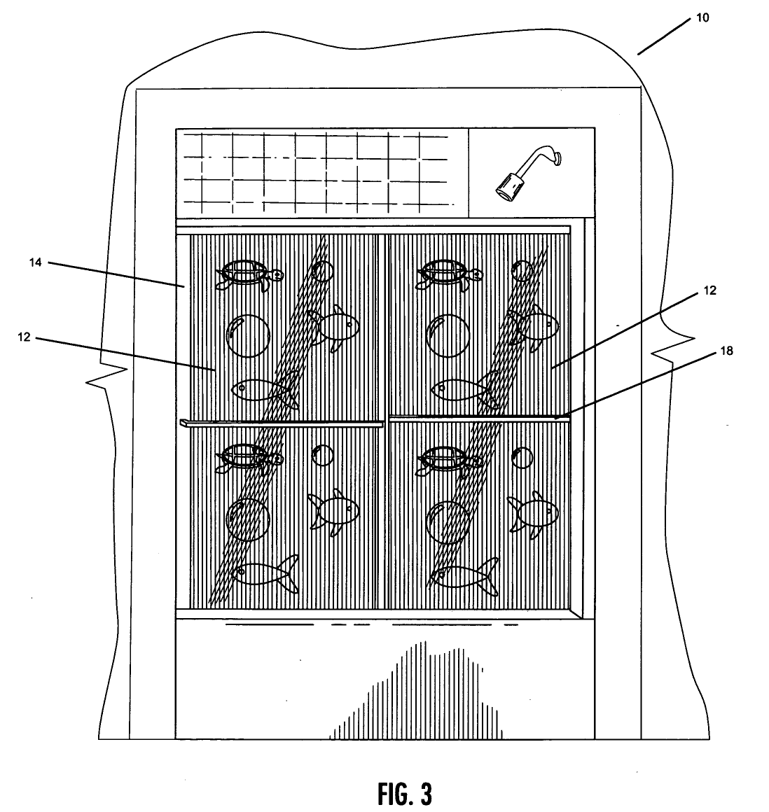

FIGS. 1-3 depict embodiments of enclosures 10 with a door member 12. The door member 12 may be pivotable or hinged, as in FIG. 1, bifolding, as in FIG. 2, sliding, as in FIG. 3, or any other typical shower door arrangement. In one embodiment, the door member 12 conveys a lenticular image (as explained in more detail below) to someone on the exterior of the enclosure 10. In alternate embodiments, the door member may also convey a lenticular image to someone on the interior of the enclosure 10.

Further, in some embodiments, the door member 12 includes a continuous lenticular image on its entire surface. However, alternately, only a portion of the door member 12 may include a lenticular image or the door member may include a plurality of lenticular images.

The door member 12 may be enclosed within a frame 14 at its edges about at least a portion of the door member's perimeter. The frame 14 may be a metallic material, such as aluminum or steel, or a suitable plastic. The frame 14 may be used for mounting the door member adjacent the shower/bathing area. The frame 14 also serves to limit ingress of water adjacent the edges of the door member 12. As explained in more detail below, the door member 12 is preferably formed of multiple layers which may be adhered, wherein at least some of the layers include images printed thereon. Accordingly, if water enters between the layers, it could cause the layers to become unadhered, cause the printed images to run or fade, cause a fogged door, or cause other potential problems. Therefore, the frame on the door member edges limits water flowing between the layers of the door member. In one embodiment, the frame 14 creates a seal around the edge of the door member 12 to substantially prevent the ingress of water. For example, the frame 14 may be clamped in a tight fit onto the door member 12 or it may be adhered to the door member 12 by a water-proof sealant and/or adhesive.

In alternate embodiments, alone or in combination with a water-sealed frame, the edges of the door member may be coated with a water-proofing agent, such as marine grade caulk. Alternately, other suitable methods of limiting ingress of water into the door member may be used. For example, lamination interfacially adhering the layers of the door members together may be sufficient to limit the ingress of water.

Other typical shower door accessories may be attached to the door member or frame, such as a handle 16 or towel bar 18.

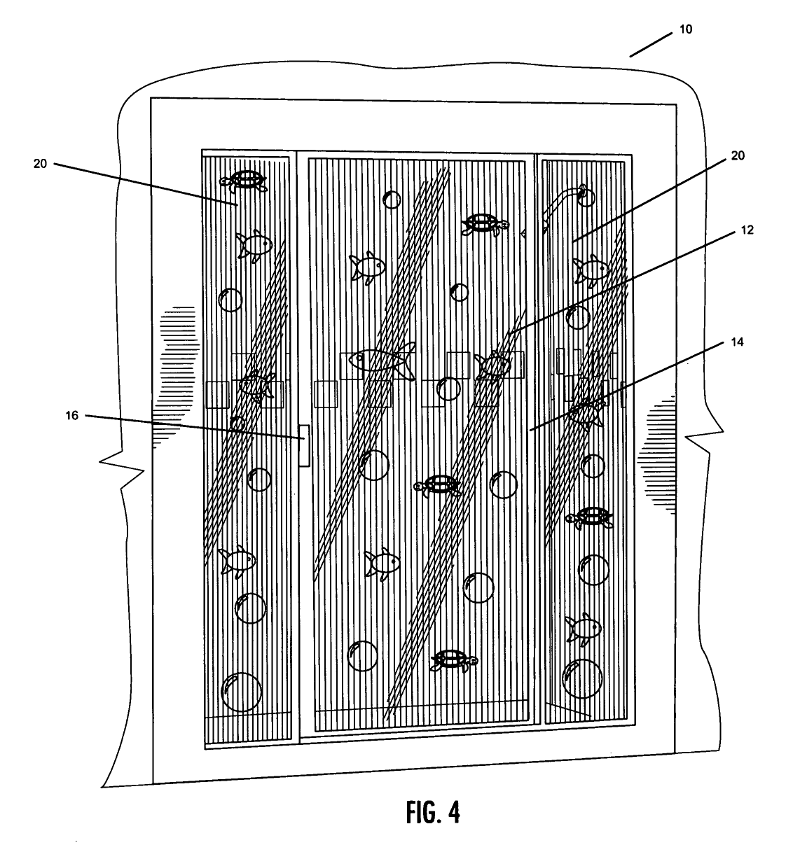

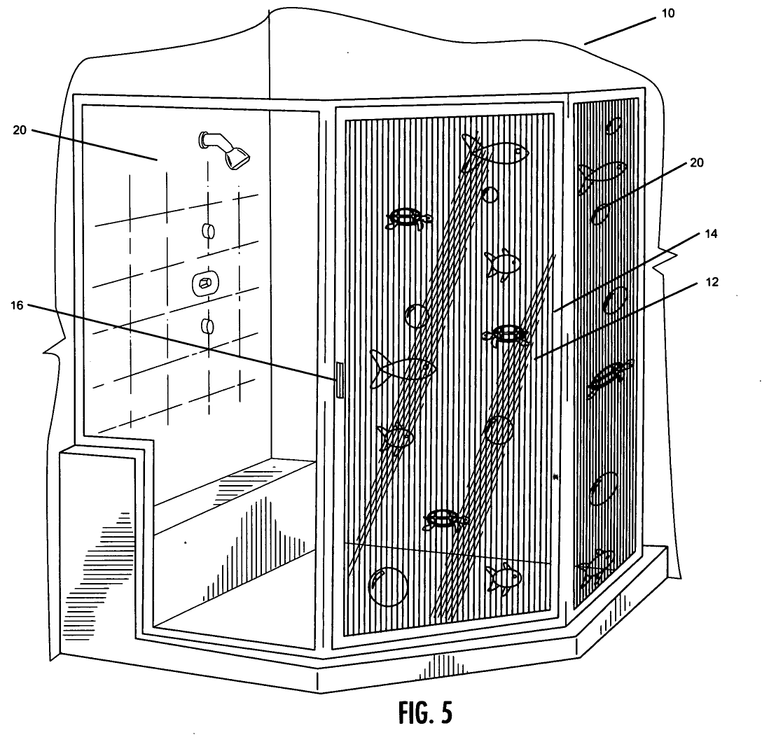

As shown in FIGS. 4-6, the enclosure 10 may include wall panels 20 in addition to a door member 12. In the embodiment shown in FIG. 4, the wall panels 20 include a lenticular image similar to the door member 12. However, in alternate embodiments such as in FIGS. 5 & 6, only a portion of the wall panels 20 include a lenticular image. In other alternate embodiments, the wall panels do not include a lenticular image.

The lenticular images on the door members 12 and wall panels 20 are created by a lenticular lens layer 22 focusing on alternately interlaced images printed either on the lenticular lens layer 22 itself or a separate substrate layer 24. The interlaced images contain at least two separate images formed on a computer with commercially available image editing software and applied with commercially available printers.

A lens side 26 of the lenticular lens layer 22 is a non-planar surface defining a series of elongated parallel lenticular formations of narrow width and substantially uniform size and shape, forming parallel lenses. The lenticular lens layer 22 may be made of a substantially transparent polymer, such as PETG or acrylic. The interlaced image is either located on an image side 28 of the lenticular lens layer 22 or on the separate substrate layer 24 adhered substantially adjacent the image side 28 of the lenticular lens layer 22. The parallel lenses have a predetermined focal length correlated with the thickness of the lenticular lens layer 22 so as to focus substantially on the interlaced image, providing a desired three-dimensional image, moving image, flipping image, or other visual effect. The image side 28 is substantially smooth.

The substrate layer 24 may be provided, for example, by a polymer based film. Such a film may be laminated to the lenticular lens layer 22 and provides water-resistant properties. Polymer films also may be formed to allow light to pass through, thereby limiting the feeling of being closed within the shower enclosure 10. In alternate embodiments, the substrate layer 24 may also be formed of any number of materials onto which an interlaced image may be printed, including, but not limited to, glass, acrylic, and metals. Paper-based substrates may be used, but have some disadvantages, because any water that comes into contact with the substrate layer could easily destroy a paper substrate and the printed image.

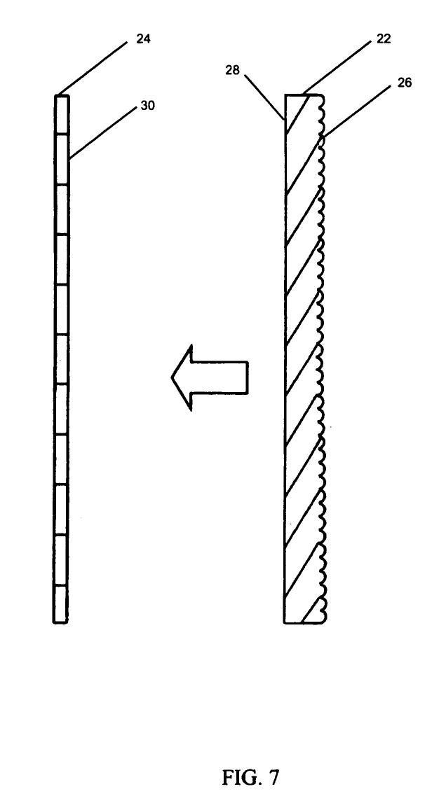

Various embodiments of the construction of the door members 12 and wall panels 20 including the lenticular lens layer 22 and the separate substrate layer 24 are shown in FIGS. 7-12. In manufacture, the lenticular lens layer 22 is aligned with an interlaced image on the substrate layer 24 and the image side of the lenticular lens layer 22 is adhered to an image side 30 of the substrate layer 24. The adhesion can be performed by various lamination or adhering processes such as cold-laminating or by using ultraviolet sensitive adhesive.

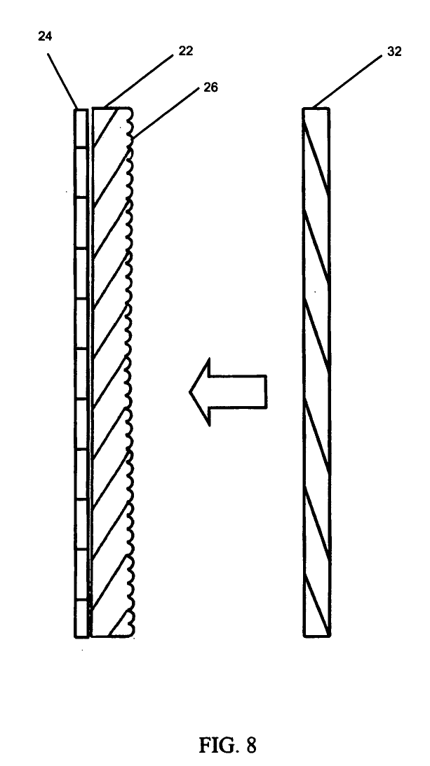

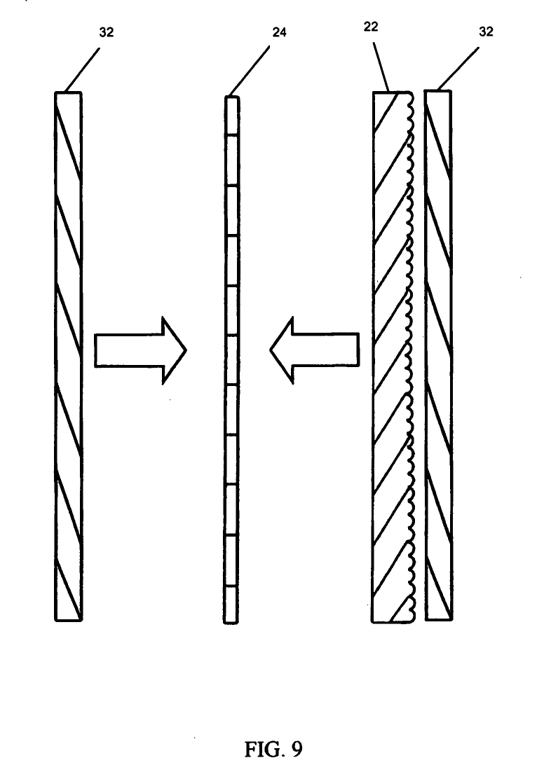

The door member 12 or wall panel 20 created by the construction of FIG. 7, which includes only the lenticular lens layer 22 and the substrate layer 24 may be sufficient for use as a shower or bath enclosure, especially when the substrate is glass or some other substantially rigid material that will provide protection to the interlaced-image. However, as shown in FIG. 8, a substantially transparent protective layer 32 may be adhered to the lens side of the lenticular layer 20 to prevent scratching or other damage to the lens, which could distort the lenticular image. Also, as shown in FIG. 9, the substantially transparent protective layer 32 may be adhered to the substrate layer 24 as well, especially when the substrate is a polymeric film or other material which could be easily damaged. The protective layers 32 also prevent damage to the lenticular lens layer and the substrate layer 24 by limiting the ability of water to reach the interior layers of the door member/wall panel and potentially affecting the interlaced image printed on the substrate. The protective layers 32 are preferably glass or a substantially transparent polymer.

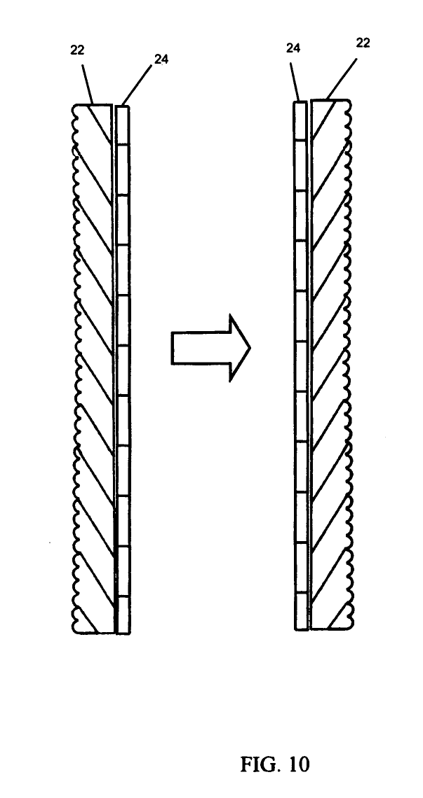

When a single lenticular lens layer 20 is used, only a person substantially facing the lens side 26 of the lenticular lens layer will see a lenticular image. Accordingly, as shown in FIG. 10, two pair of the lenticular lens layers 20 and the substrate layers 22 may be adhered to each other so that the lens sides 26 of lenticular lens layers 20 are disposed on both sides of a door member 12. Therefore, people on either side of the door member 12 or wall panel 20 can see a lenticular image. In one embodiment, the images printed on the image sides 30 of the substrate layers 22 are mirror images so that people on both sides of the door member 12 or wall panel 20 see substantially the same lenticular image.

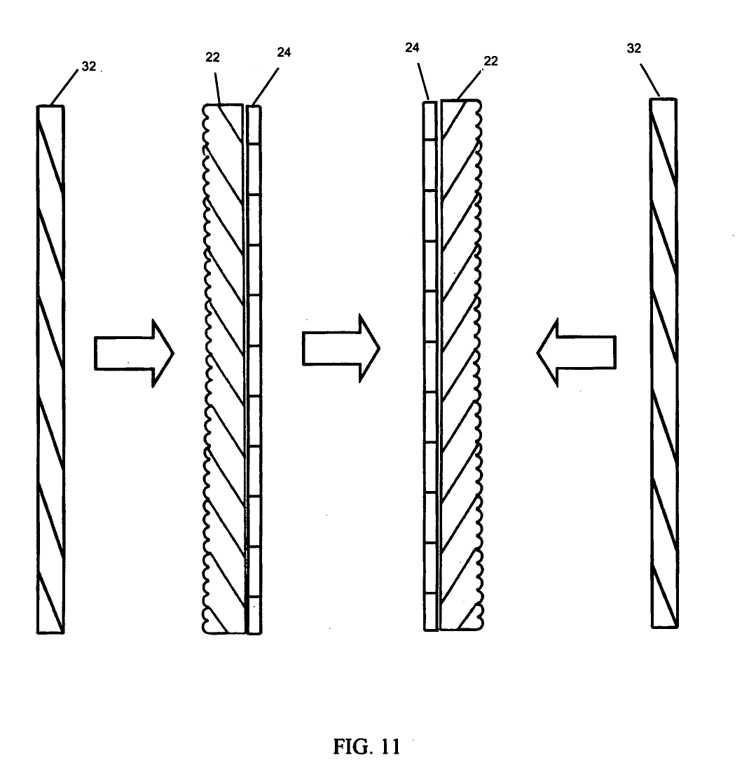

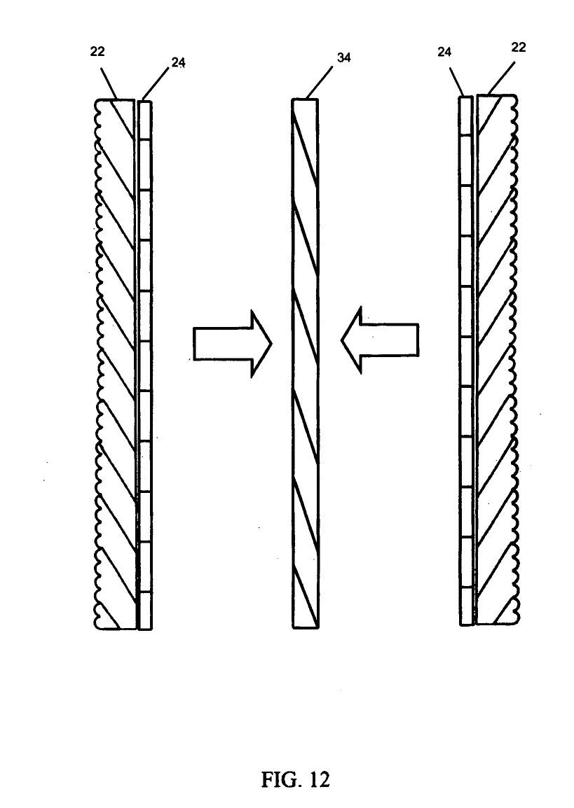

As shown in FIG. 11, the embodiment of FIG. 10 may be sandwiched between protective layers 32 to provide protection to the lenticular lens layers 20. In another alternate embodiment, shown in FIG. 12, the substrate layers 22 in a double sided lenticular door member 12 may be adhered to an interior layer 34, rather than to each other. In yet another alternate embodiment, images may be printed on both sides of a single substrate layer 22 and lenticular lens layers 20 may be adhered to both sides of the substrate layer 22.

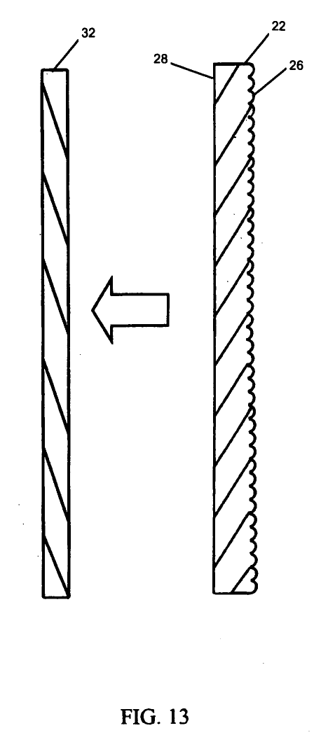

As shown in FIG. 13, in alternate embodiments where the interlaced image is printed directly onto the lenticular lens layer 20, the protective layer 32 is located on at least the image side 28 of the lenticular lens layer to prevent damage to the interlaced image. The protective layer 32 may also be used on the lens side of the lenticular lens layer 20. After the door member 12 or wall panel 20 is constructed, it may be enclosed within,the frame 14 and sealed to limit water flowing between layers of the door member 12.

In further alternate embodiments, where the interlaced image is printed directly onto the lenticular lens layer 20, the protective layer 32 is not used. As one example, the lenticular lens layer 20 with a printed image may be provided to a consumer as a polymer film or otherwise for after-market application to an existing shower door.

The foregoing descriptions of embodiments according to the disclosure have been presented for purposes of illustration and description. They are not intended to be exhaustive or to limit the disclosure to the precise form disclosed. Obvious modifications or variations are possible in light of the above teachings. The embodiments are chosen and described in an effort to provide the best illustrations of the disclosure and its practical application, and to thereby enable one of ordinary skill in the art to utilize the various embodiments and with various modifications as are suited to the particular use contemplated. All such modifications and variations are within the scope of the claims when interpreted in accordance with the breadth to which they are fairly, legally, and equitably entitled.

What is claimed is:

1. An enclosure for enclosing a bathing area, the enclosure comprising a door member including a first substrate layer having a first interlaced image layer printed on a first surface thereof; and a first lenticular lens layer operably disposed adjacent said first interlaced image layer so as to define, in conjunction with said first interlaced image layer, a first lenticular image, wherein the first substrate layer and the first lenticular lens layer are arranged such that the first lenticular image is displayed to a viewer adjacent the enclosure.

2. The enclosure of claim 1, further comprising one or more enclosure members.

3. The enclosure of claim 1, wherein the first interlaced image layer is a substantially continuous layer.

4. The enclosure of claim 1, wherein the first interlaced image layer is a discontinuous layer.

5. The enclosure of claim 1, further comprising a frame sealingly supporting the layers of the door member such that ingress of water into the door member is limited.

6. The enclosure of claim 1, wherein the first substrate layer comprises a polymeric film material laminated to the first lenticular lens layer.

7. The enclosure of claim 1, wherein the door member firther comprises a first protective layer adjacent the first lenticular lens layer.

8. The enclosure of claim 1, wherein the door member further comprises a second protective layer adjacent the first substrate layer, such that the first substrate layer is positioned between the first lenticular lens layer and the second protective layer.

9. The enclosure of claim 2, wherein at least one of the enclosure members further comprises:
(a) a frame; and
(b) a panel including an enclosure member substrate layer having an enclosure member interlaced image layer printed on a first surface thereof; and an enclosure member lenticular lens layer operably disposed adjacent said enclosure member interlaced image layer so as to define, in conjunction with said enclosure member interlaced image layer, an enclosure member lenticular image, wherein the enclosure member substrate layer and the enclosure member lenticular lens layer are arranged such that the enclosure member lenticular image is displayed to a viewer adjacent the enclosure.

10. The enclosure of claim 1, wherein the door member further comprises a second substrate layer having a second interlaced image layer printed on a first surface thereof; and a second lenticular lens layer operably disposed adjacent said second interlaced image layer so as to define, in conjunction with said second interlaced image layer, a second lenticular image, wherein the second substrate layer and the second lenticular lens layer are arranged such that the second lenticular image is displayed in a direction substantially opposite to the displayed first lenticular image.

11. The enclosure of claim 10, wherein the door member further comprises a first protective layer arranged adjacent the first lenticular lens layer such that the first protective layer defines an outer surface of the door member and a second protective layer arranged adjacent the second lenticular lens layer, such that the first lenticular lens layer, the first substrate layer, the second substrate layer, and the second lenticular lens layer are arranged between the first protective layer and the second protective layer.

12. The enclosure of claim 10, wherein the second interlaced image is a mirror image of the first interlaced image.

13. The enclosure of claim 1, wherein the door member further comprises a second interlaced image layer printed on a second surface of the first substrate; and a second lenticular lens layer operably disposed adjacent said second interlaced image layer so as to define, in conjunction with said second interlaced image layer, a second lenticular image, wherein the first substrate layer and the second lenticular lens layer are arranged such that the second lenticular image is displayed in a direction substantially opposite to the first lenticular image.

14. The enclosure of claim 13, wherein the door member further comprises a first protective layer arranged adjacent the first lenticular lens layer such that the first protective layer defines an outer surface of the door member and a second protective layer arranged adjacent the second lenticular lens layer such that the first lenticular lens layer, the first substrate layer, and the second lenticular lens layer are arranged between the first protective layer and the second protective layer.

15. The enclosure of claim 13, wherein the second interlaced image is a mirror image of the first interlaced image.

16. An enclosure for enclosing a bathing area, the enclosure comprising a door member including a first lenticular lens layer with a first interlaced image layer printed on a first printed surface thereof, so as to define, in conjunction with said first interlaced image layer, a first lenticular image displayed to a viewer adjacent the enclosure.

17. The enclosure of claim 16, further comprising a frame sealingly supporting the layers of the door member such that ingress of water into the door member is limited.

18. The enclosure of claim 16, wherein the door member further comprises a first protective layer arranged adjacent the first lenticular lens layer such that the first protective layer defines an outer surface of the door member and a second protective layer arranged adjacent the first interlaced image layer such that the first lenticular lens layer is arranged between the first protective layer and the second protective layer.

19. The enclosure of claim 16, wherein the door member further comprises a second lenticular lens layer with a second interlaced image layer printed on a first printed surface thereof, so as to define, in conjunction with said second interlaced image layer, a second lenticular image displayed in a direction substantially opposite the displayed first lenticular image.

20. The enclosure of claim 16, wherein the first lenticular image is displayed to a viewer within the enclosure.

21. The enclosure of claim 16, wherein the first lenticular image is displayed to a viewer outside the enclosure.

22. An enclosure for enclosing a bathing area comprising a lenticular lens layer operably disposed adjacent an interlaced image layer so as to define, in conjunction with said interlaced image layer, a lenticular image, wherein the interlaced image layer is sealably disposed between the lenticular lens layer and a protective layer.

23. The enclosure of claim 22, wherein the interlaced image layer is sealably disposed between the lenticular lens layer and the protective layer by sealing about the edge of the layers.

24. The enclosure of claim 22, wherein the interlaced image layer is sealably disposed between the lenticular lens layer and the protective layer by interfacial sealing.

25. The enclosure of claim 22, wherein the interlaced image layer is printed on the protective layer.

26. The enclosure of claim 22, wherein the interlaced image layer is printed on the lenticular lens layer.

27. A method for making an enclosure member, the method comprising the steps of:
(a) printing an interlaced image on a smooth surface of a polymeric film having a lenticular lens surface opposite the smooth surface, wherein the interlaced image is oriented with the lenticular lens surface such that a lenticular image is displayed; and
(b) adhering the polymeric film to the enclosure member in order to display the lenticular image toward the exterior of the enclosure member.
